(19) United States
(12) Patent Application Publication
(10) Pub. No.: US 2025/0105381 A1
(43) Pub. Date: Mar. 27, 2025

(54) ROTATING CHARGE/DISCHARGE DEVICE AND METHOD OF ACTIVATING SECONDARY BATTERY USING THE SAME

(71) Applicant: SAMSUNG SDI CO., LTD., Yongin-si (KR)

(72) Inventors: Chiyoung KIM, Yongin-si (KR); Chan Yoon JUNG, Yongin-si (KR); Jehyun LEE, Yongin-si (KR)

(21) Appl. No.: 18/746,367

(22) Filed: Jun. 18, 2024

(30) Foreign Application Priority Data
Sep. 27, 2023 (KR) 10-2023-0130987

(51) Int. Cl. H01M 10/44; H01M 10/0585

(52) U.S. Cl. CPC H01M 10/446; H01M 10/0585

(57) ABSTRACT

A rotating charge/discharge device includes a cell fixing portion configured to fix at least one battery cell, a major surface of the cell fixing portion being perpendicular to a gravity direction, a cell activating portion that includes a charge/discharge portion, a positive electrode connector connecting a positive electrode lead of the at least one battery cell and the charge/discharge portion, and a negative electrode connector connecting a negative electrode lead of the at least one battery cell and the charge/discharge portion, the cell activating portion being configured to charge and discharge the at least one battery cell, and a cell rotating portion that includes a rotating shaft coupled to the cell fixing portion and extending in parallel to the major surface of the cell fixing portion, and a rotating driver periodically rotating the rotating shaft with the cell fixing portion.

### CROSS-REFERENCE TO RELATED APPLICATION

This application claims priority to and the benefit of Korean Patent Application No. 10-2023-0130987, filed in the Korean Intellectual Property Office on Sep. 27, 2023, the entire contents of which are incorporated herein by reference.

### BACKGROUND

### 1. Field

The present disclosure relates to a manufacturing process of a secondary battery, and more particularly, to a rotating charge/discharge device for an activation process of a secondary battery and a method of activating the secondary battery using the same.

### 2. Description of the Related Art

Rechargeable secondary batteries are used for various purposes, such as power sources for small electronic devices (e.g., mobile phones and laptop computers) and power sources for driving motors for transportation vehicles (e.g., electric vehicles and hybrid vehicles). The secondary battery may include an electrode assembly and a case for accommodating and sealing the electrode assembly, and may be classified into, e.g., a cylindrical battery, a prismatic battery, and a pouch-type battery depending on its appearance.

The formation process of a secondary battery is a finishing process of applying electrical characteristics to an assembled battery cell and determining whether there is a defect. The formation process is largely divided into an activation process, a defective cell removal process, and a capacity selection process. The activation process stabilizes the battery cells and makes them usable by repeatedly charging, aging, and discharging the assembled battery cells.

### SUMMARY

An embodiment provides a rotating charge/discharge device including a cell fixing portion configured to fix at least one battery cell, a major surface of the cell fixing portion being perpendicular to a gravity direction, a cell activating portion that includes a charge/discharge portion, a positive electrode connector connecting a positive electrode lead of the at least one battery cell and the charge/discharge portion, and a negative electrode connector connecting a negative electrode lead of the at least one battery cell and the charge/discharge portion, the cell activating portion being configured to charge and discharge the at least one battery cell, and a cell rotating portion that includes a rotating shaft coupled to the cell fixing portion and a rotating driver rotating the rotating shaft, the rotating shaft extending in parallel to the major surface of the cell fixing portion, and the rotating driver being configured to periodically rotate the rotating shaft with the cell fixing portion during an activating process of the at last one battery cell.

The charge/discharge portion may include a power source and a load, the charge/discharge portion being configured to charge the battery cell via the power source and to discharge the battery cell via the load.

Each of the positive electrode connector and the negative electrode connector may be a connecting line, the connecting line having a length that allows free movement if the cell fixing portion rotates.

The rotating shaft may extend in parallel to a height direction of the at least one battery cell, the rotating driver may be coupled to a first end of the rotating shaft, and a second end of the rotating shaft may be supported by a bearing.

The cell fixing portion may include a lower plate configured to support the at least one battery cell, an upper plate in parallel to the lower plate and covering the lower plate, and a fastening portion coupling the upper plate and the lower plate and configured to adjust pressure between the upper plate and the lower plate.

The rotating shaft may be fixed to one of the upper plate and the lower plate, the rotating shaft overlapping a central axis of the cell fixing portion.

The cell fixing portion may include a plurality of stacked support plates and a fastening portion coupling the plurality of stacked support plates to each other, the plurality of stacked support plates being configured to support a plurality of battery cells in a plurality of layers and a plurality of columns between the plurality of support plates.

A plurality of the positive and negative electrode connectors may connect the plurality of battery cells and the charge/discharge portion, and the plurality of positive and negative electrode connectors and the charge/discharge portion may be fixed to one of the plurality of support plates.

The rotating shaft may be fixed to at least one of the plurality of support plates, the rotating shaft extending in parallel to the height direction of the plurality of battery cells between two adjacent columns of the plurality of columns.

An embodiment provides a method of activating a secondary battery, including disposing and fixing at least one battery cell onto a cell fixing portion so that a thickness direction of the at least one battery cell coincides with a gravity direction, the cell fixing portion including a rotating shaft in parallel to a height direction of the at least one battery cell, electrically connecting the at least one battery cell to a charge/discharge portion, and activating the at least one battery cell by repeatedly performing charging, aging, and discharging by an operation of the charge/discharge portion, and at the same time, rotating the cell fixing portion and the at least one battery cell by rotation of the rotating shaft.

Disposing and fixing the at least one battery cell may include disposing and fixing a plurality of battery cells in a plurality of layers and a plurality of columns in the cell fixing portion, and the rotating shaft may be disposed correspondingly between two adjacent columns among the plurality of columns.

Electrically connecting the at least one battery cell to the charge/discharge portion may include electrically connecting the charge/discharge portion to each of the plurality of battery cells by a plurality of positive electrode connectors and a plurality of negative electrode connectors, and each of the charge/discharge portion, the plurality of positive electrode connectors, and the plurality of negative electrode connectors may be fixed to the cell fixing portion, and rotates together with the cell fixing portion during rotation of the rotating shaft.

Activating the at least one battery cell may include repeatedly rotating the rotating shaft in a first direction by 180° to invert upper and lower portions of the at least one battery cell and rotating the rotating shaft in a second direction by 180° to invert the upper and lower portions of the at least one battery cell back.

Activating the at least one battery cell may include rotating the rotating shaft repeatedly by 180° in the first direction, by 180° in the second direction, by 180° rotating operation in the second direction, and by 180° in the first direction, in the stated order.

Activating the at least one battery cell may include stopping the rotating shaft for a rotating stop period between rotations in the first direction and the second direction.

### BRIEF DESCRIPTION OF THE DRAWINGS

Features will become apparent to those of skill in the art by describing in detail exemplary embodiments with reference to the attached drawings, in which:

FIG. 1 illustrates a schematic perspective view of a rotating charge/discharge device according to a first embodiment.

FIG. 2 illustrates an exploded perspective view of the rotating charge/discharge device illustrated in FIG. 1.

FIG. 3 illustrates a side view of the rotating charge/discharge device illustrated in FIG. 1.

FIG. 4 illustrates a perspective view of a pouch-type battery cell.

FIG. 5 illustrates a partially enlarged cross-sectional view of an electrode assembly of the battery cell illustrated in FIG. 4.

FIG. 6 and FIG. 7 illustrate schematic views of a rotation process of a battery cell using the rotating charge/discharge device illustrated in FIG. 1.

FIG. 8 illustrates a front view of a rotating charge/discharge device according to a second embodiment.

FIG. 9 and FIG. 10 illustrate schematic views of a rotation process of a plurality of battery cells using the rotating charge/discharge device illustrated in FIG. 8.

FIG. 11 illustrates a flowchart of a method of activating a secondary battery according to a third embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

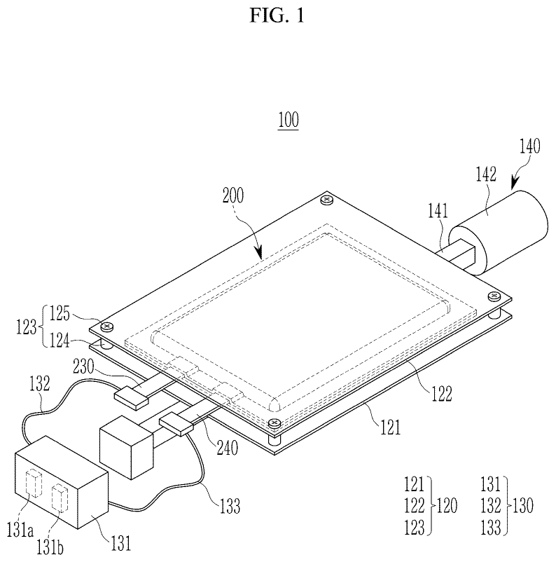

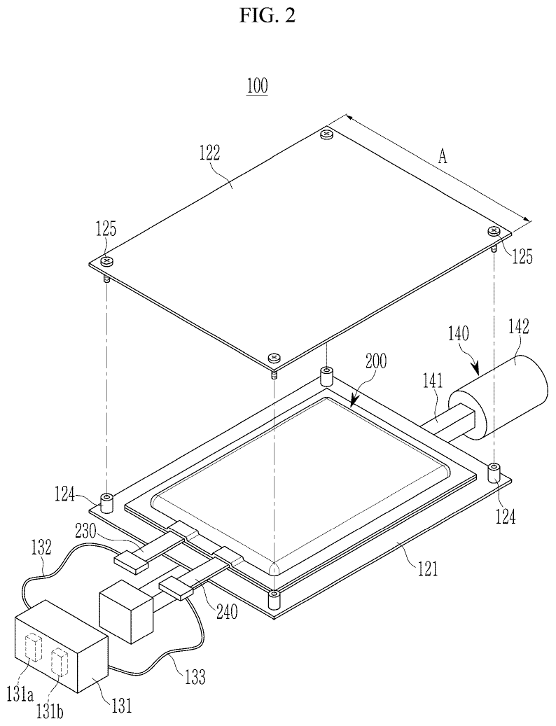

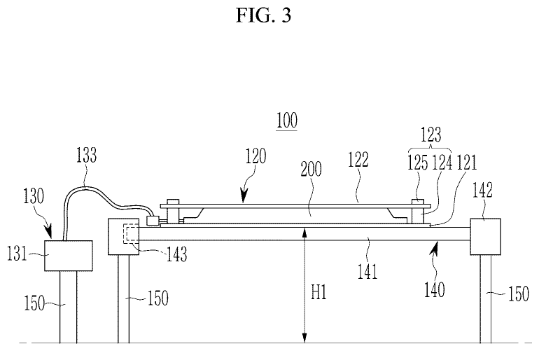

FIG. 1 illustrates a schematic perspective view of a rotating charge/discharge device according to a first embodiment, FIG. 2 illustrates an exploded perspective view of the rotating charge/discharge device illustrated in FIG. 1, and FIG. 3 illustrates a side view of the rotating charge/discharge device illustrated in FIG. 1.

Referring to FIG. 1 to FIG. 3, a rotating charge/discharge device 100 is a device for an activation process of a battery cell 200, and may include a cell fixing portion 120, a cell activating portion 130, and a cell rotating portion 140. For example, the rotating charge/discharge device 100 may be implemented for activating the pouch-type battery cell 200.

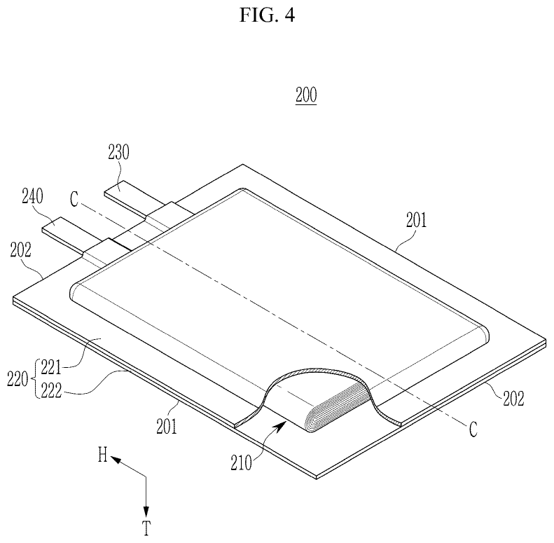

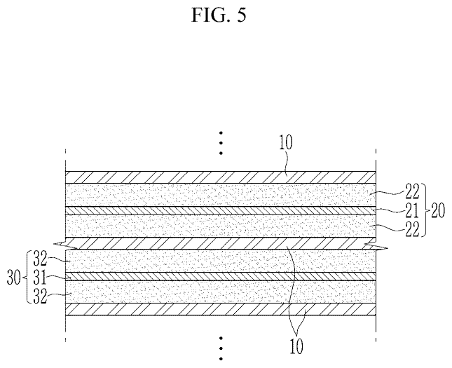

FIG. 4 illustrates a perspective view of a pouch-type battery cell, and FIG. 5 illustrates a partially enlarged cross-sectional view of an electrode assembly of the battery cell illustrated in FIG. 4.

Referring to FIG. 4 and FIG. 5, the pouch-type battery cell 200 may include a case 220 for accommodating and sealing an electrode assembly 210 together with an electrolyte solution, and a positive electrode lead 230 and a negative electrode lead 240 exposed to the outside of the case 220. The electrode assembly 210 may include a plurality of positive electrodes 20 and a plurality of negative electrodes 30 that are alternately stacked one by one with a separator 10 therebetween. The positive electrode lead 230 is electrically connected to the plurality of positive electrodes 20, and the negative electrode lead 240 is electrically connected to the plurality of negative electrodes 30.

The positive electrode 20 may include a positive electrode substrate 21 and a positive electrode combined layer 22 disposed on the positive electrode substrate 21. The negative electrode 30 may include a negative electrode substrate 31 and a negative electrode combined layer 32 disposed on the negative electrode substrate 31. The positive electrode substrate 21 may be configured of an aluminum foil, and the positive electrode combined layer 22 may include a transition metal oxide, e.g., LiCoO₂, LiNiO₂, LiMn₂O₄, Li(NiCoAl)O₂, LiFePO₄, or Li(NiCoMn)O₂, a conductive material, a binder, and the like. The negative electrode substrate 31 may be configured of a copper foil or a nickel foil, and the negative electrode combined layer 32 may include graphite, a conductive material, and a binder.

The separator 10 may include a polymer material, e.g., polyethylene or polypropylene, and may insulate the positive electrode 20 and the negative electrode 30 while allowing movement of lithium ions. The electrolyte solution may include an electrolyte salt and a solvent, and may additionally include various types of additives. The electrolyte salt may include, e.g., LiPF₆ and the like, and the solvent may include one of, e.g., ethylene carbonate, ethyl methyl carbonate, and dimethyl carbonate.

The case 220 may include an upper sheet 221 and a lower sheet 222, and edges of the upper sheet 221 and lower sheet 222 may be integrally bonded, e.g., by thermal fusion. Each of the upper sheet 221 and the lower sheet 222 may include a metal sheet and a plurality of polymer sheets covering inner and outer surfaces of the metal sheet.

The metal sheet may be an aluminum sheet and may provide mechanical strength to the case 220. The polymer sheet may include one of, e.g., a polyethylene terephthalate (PET) sheet, a nylon sheet, and a PET-nylon composite sheet, and may provide insulation and protection to the case 220.

Referring to FIG. 1 to FIG. 4, the battery cell 200 input into the rotating charge/discharge device 100 may be a battery cell immediately after assembly is completed. The battery cell 200 may be configured to have a rectangular shape, and may include a pair of long sides 201 and a pair of short sides 202. The positive electrode lead 230 and the negative electrode lead 240 may be disposed at a distance from each other on one short side 202.

The rotating charge/discharge device 100 may include the cell fixing portion 120 that fixes the battery cell 200, the cell activating portion 130 that provides electrical characteristics to the battery cell 200 by repeatedly charging, aging, and discharging the battery cell 200, and the cell rotating portion 140 that is coupled to the cell fixing portion 120 and periodically rotates the cell fixing portion 120 during the activating process.

The cell fixing portion 120 may fix (e.g., hold and secure) the battery cell 200 so that the battery cell 200 does not move or shake during the activating process. The cell fixing portion 120 may be configured of two support plates that may be coupled and separated, and the pressure applied to the battery cell 200 may be adjusted by controlling the coupling force of the two support plates. For example, the cell fixing portion 120 may include a lower plate 121 on which the battery cell 200 is disposed, an upper plate 122 covering the lower plate 121 and the battery cell 200, and a fastening portion 123 coupling the lower plate 121 and the upper plate 122.

The fastening portion 123 may be used as long as it may separate and couple the upper plate 122 and the lower plate 121 and control the coupling force. For example, the fastening portion 123 may be configured of a plurality of supports 124 fixed to the lower plate 121 and a plurality of fastening bolts 125 that penetrate the upper plate 122 and are respectively fastened to the plurality of supports 124.

A screw hole may be disposed inside each of the plurality of supports 124, and the fastening bolt 125 may be fastened to the screw hole to couple the upper plate 122 and the lower plate 121. The pressure applied to the battery cell 200 (e.g., by coupling the lower and upper plates 121 and 122 to each other with the battery cell 200 therebetween) may be adjusted depending on the degree of tightening of the fastening bolt 125.

The cell fixing portion 120 disposes and fixes the battery cell 200 so that the thickness direction (T direction in FIG. 4) of the battery cell 200 may coincide with the direction of gravity (e.g., the thickness direction may extend along a normal to the large surfaces of the lower and upper plates 121 and 122 in FIG. 1). The thickness direction (T direction) of the battery cell 200 coincides with the stacking direction of the positive electrode 20 and the negative electrode 30 configuring the electrode assembly 210. The battery cell 200 may be disposed on the cell fixing portion 120 so that its height direction (H direction in FIG. 4) is parallel to the ground (e.g., the height direction may be parallel to the large surfaces of the lower and upper plates 121 and 122). The positive electrode lead 230 and the negative electrode lead 240 may be disposed parallel to the ground (i.e., along the height direction). The large surfaces of the lower and upper plates 121 and 122 may be referred to as a major surface of the cell fixing portion 120.

The cell activating portion 130 may include a charge/discharge portion 131, a positive electrode connector 132 connecting the positive electrode lead 230 to the charge/discharge portion 131, and a negative electrode connector 133 connecting the negative electrode lead 240 to the charge/discharge portion 131. The charge/discharge portion 131 may include a power source 131a and a load 131b, capable of on/off control, respectively. The positive electrode connector 132 is connected to the positive electrode lead 230, and the negative electrode connector 133 is connected to the negative electrode lead 240.

Each of the positive electrode connector 132 and the negative electrode connector 133 may be configured of (e.g., may include) a connecting wire, and may be provided with a sufficient length so as not to interfere with the rotation of the cell fixing portion 120 and the battery cell 200 by the operation of the cell rotating portion 140. That is, each of the positive electrode connector 132 and the negative electrode connector 133 may be provided at a length that allows movement if the cell fixing portion 120 rotates. For example, a length of each of the positive electrode connector 132 and the negative electrode connector 133 may be longer than a distance between the charge/discharge portion 131 and a corresponding one of the positive and negative electrode leads 230 and 240, e.g., a length of each of the positive and negative electrode connector 132 and 133 may be 50% longer than a distance between the charge/discharge portion 131 and a corresponding one of the positive and negative electrode leads 230 and 240.

If the power of the charge/discharge portion 131 is turned on, the battery cells 200 may be charged, and if the power thereof is turned off and the load is turned on, the battery cells 200 may be discharged. The cell activating portion 130 makes the battery cell 200 usable and stabilizes the battery cell 200 by repeatedly charging, aging, and discharging the battery cell 200. Aging is a step of maintaining a constant temperature and humidity for sufficient impregnation of the electrolyte solution, and both the power source and the load are turned off.

The cell rotating portion 140 may include a rotating shaft 141 coupled to the cell fixing portion 120 so as to be parallel to the ground, and a rotating driver 142 coupled to the rotating shaft 141 to provide rotation power to the rotating shaft 141. The rotating shaft 141 may extend lengthwise along the height direction and may be fixed to (e.g., attached directly to) the lower surface of the lower plate 121, and the rotating driver 142 may be configured of (e.g., may include) an electric motor, e.g., a step motor.

A first end of the rotating shaft 141 may be coupled to the rotating driver 142, and a second end of the rotating shaft 141 (i.e., an end opposite to the first end in the height direction) may be supported by a bearing 143. For example, as illustrated in FIG. 3, the rotating shaft 141 may have a longer length in the height direction than each of the lower and upper plates 121 and 122, and the first and second ends of the rotating shaft 141 may protrude beyond opposite respective sides of the cell fixing portion 120 in the height direction. The rotating shaft 141 may be parallel to the positive electrode lead 230 and the negative electrode lead 240, and may be disposed correspondingly between the positive electrode lead 230 and the negative electrode lead 240. That is, the rotating shaft 141 may be disposed below the central axis of the battery cell 200. The central axis of the battery cell 200 is an imaginary axis (i.e., along line C-C in FIG. 4) that maintains a same distance from the two long sides 201 of the battery cell 200, while being parallel to the height direction (i.e., H direction in FIG. 4).

The cell fixing portion 120 may be installed to have a predetermined separation height (H1 in FIG. 3) with respect to the floor surface so as not to collide with the floor surface if rotated by the rotating shaft 141, e.g., a distance between a lowermost surface of the cell fixing portion 120 and a surface supporting a support 150 of the cell fixing portion 120 may be H1. If the width of each of the upper plate 122 and the lower plate 121 measured along the direction perpendicular to the rotating shaft 141 is “A” (see FIG. 2), the separation height H1 of the lower plate 121 with respect to the floor surface should be greater than half of A. To secure this separation height, the cell fixing portion 120 and the cell rotating portion 140 may be installed on the support 150.

The cell rotating portion 140 rotates the battery cell 200 during the activating process of the battery cell 200 so that the electrode assembly 210 is sufficiently and uniformly impregnated with the electrolyte solution.

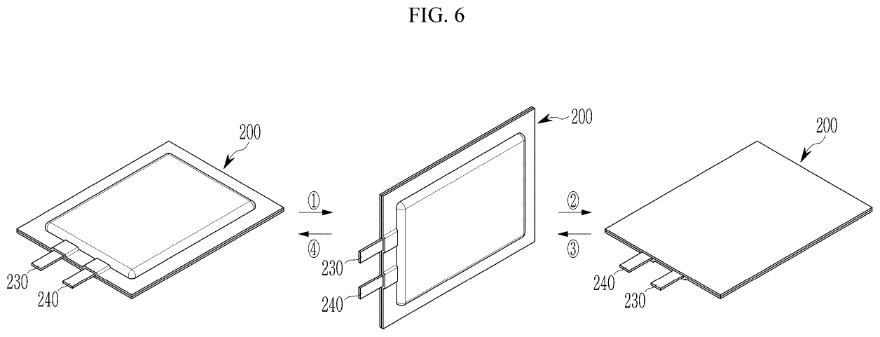

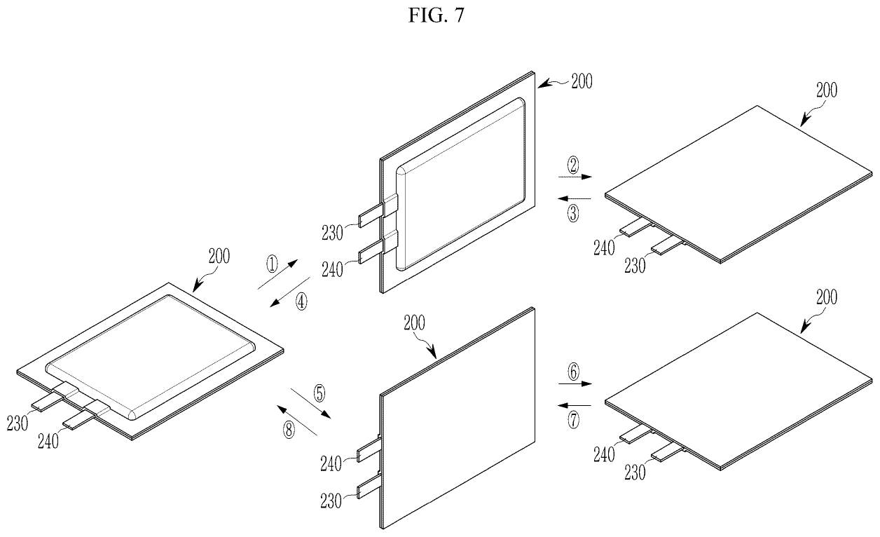

FIG. 6 and FIG. 7 illustrate schematic views of a rotation process of a battery cell using the rotating charge/discharge device illustrated in FIG. 1. Hereinafter, the first direction and the second direction are opposite to each other, and if the first direction is a clockwise direction, the second direction is a counterclockwise direction, while if the first direction is a counterclockwise direction, the second direction is a clockwise direction.

Referring to FIG. 1 and FIGS. 6 and 7, in the process of activating the battery cell 200, the rotating charge/discharge device 100 is oriented so the starting position of the battery cell 200 is oriented to have the positive and negative electrode leads 230 and 240 parallel to the ground (i.e., perpendicular to the gravity direction), and the cell rotating portion 140 rotates the battery cell 200 around its longitudinal central axis (i.e., around line C-C in FIG. 4). As such, the rotation radius of the battery cell 200 is half the length of the short side 202 of the battery cell 200.

For example, referring to FIG. 1 and FIG. 6, the cell rotating portion 140 may repeat a process of inverting (e.g., rotating) the upper and lower portions of the battery cell 200 by rotating the battery cell 200 by 180° in the first direction around its longitudinal central axis, and then inverting (e.g., rotating) the upper and lower portions of the battery cell 200 again by rotating the battery cell 200 by 180° in the second direction around its longitudinal central axis (e.g., so the battery cell 200 returns to its initial position).

In another example, referring to FIG. 1 and FIG. 7, the cell rotating portion 140 may perform the rotating operation in the second direction and the rotating operation in the first direction, after the rotating operation in the first direction and the rotating operation in the second direction. In this case, the electrolyte solution alternately flows between the upper and lower portions of the electrode assembly due to the up-and-down inversion of the battery cell 200, and also alternately flows between the left and right portions of the electrode assembly during the rotation process, so that the electrolyte solution may be more uniformly impregnated throughout the electrode assembly.

Referring to FIG. 6 and FIG. 7, in both cases, the cell rotating portion 140 may have a predetermined stop period between the rotating operation period in the first direction and the rotating operation period in the second direction. The stop period is a stabilization period in which the electrolyte solution slowly flows downwardly by gravity so that the electrode assembly is sufficiently impregnated with the electrolyte solution.

Since the electrolyte solution is in a liquid state, it is collected at the bottom of the electrode assembly by gravity. Since the battery cell 200 alternately turns upside down by rotation, the electrolyte solution does not collect in a specific portion of the electrode assembly but moves during the activation process. As a result, the electrode assembly may be uniformly impregnated with the electrolyte solution.

In this process, the flow distance of the electrolyte solution according to the rotation of the battery cell may be half the length of the short side of the battery cell 200. This shortens the flow distance of the electrolyte solution during the rotation of the battery cell 200, facilitating the flow of the electrolyte solution and enabling uniform impregnation.

If a battery cell were to be disposed so that at the starting position the positive electrode lead and the negative electrode lead were to be parallel to the direction of gravity (rather than perpendicular as in FIGS. 6 and 7), and were to be repeatedly rotated 180° in the first direction and 180° in the second direction around an imaginary rotating axis parallel to the ground, the flow distance of the electrolyte solution would have been half the length of the long side of the battery cell. In this case, the flow distance of the electrolyte solution would have been greater than that of the electrolyte in FIGS. 6 and 7. This increase in the flow distance of the electrolyte solution may hinder smooth flow of the electrolyte solution and uniform impregnation of the electrode assembly.

Referring back to FIG. 1, the rotating charge/discharge device 100 of the present embodiment may cause the electrolyte solution to be uniformly impregnated throughout the electrode assembly 210 during the process of activating the battery cell 200. As a result, the output performance of the battery cell 200 may be increased and the capacity of the battery cell 200 may be increased.

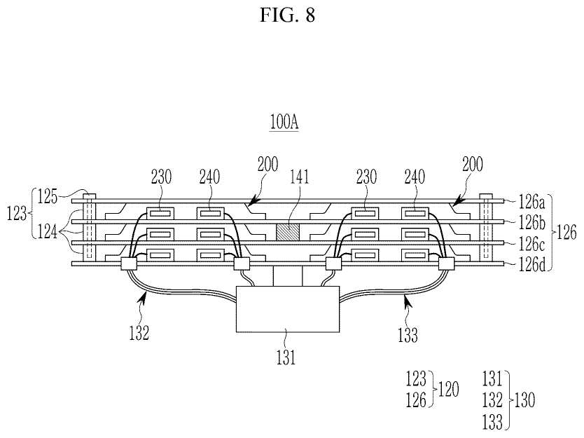

FIG. 8 illustrates a front view of a rotating charge/discharge device according to a second embodiment. The rotating charge/discharge device of the second embodiment has the same or similar configuration as the first embodiment described above, except for the configuration described below.

Referring to FIG. 8, a rotating charge/discharge device 100A of the second embodiment fixes a plurality of battery cells 200 and simultaneously activates the plurality of battery cells 200. In the cell fixing portion 120, the plurality of battery cells 200 may be disposed in a plurality of layers and a plurality of columns. For example, as illustrated in FIG. 8, six battery cells 200 disposed in three layers and two columns may be arranged in the rotating charge/discharge device 100A to be fixed and activated simultaneously. In another example, the number and disposition shape of the battery cells 200 may be adjusted in any suitable manner.

The cell fixing portion 120 may include a plurality of support plates 126, and the plurality of battery cells 200 may be disposed between two adjacent support plates 126. The fastening portion 123 may include a plurality of supports 124 and a plurality of fastening bolts 125. The plurality of supports 124 may be aligned along a vertical direction (i.e., the gravity direction), and the fastening bolt 125 may penetrate a plurality of support plates 126a, 126b, 126c, and 126d, may be fastened to the plurality of supports 124. For example, as illustrated in FIG. 8, the plurality of support plates 126a, 126b, 126c, and 126d may arranged in parallel to each other and to the ground, such that large surfaces of the battery cells 200 may be positioned on respective ones of support plates 126a, 126b, 126c, and 126d.

The cell activating portion 130 may include the charge/discharge portion 131, a plurality of positive electrode connectors 132 respectively connecting the positive electrode leads 230 of the plurality of battery cells 200 and the charge/discharge portion 131, and a plurality of negative electrode connectors 133 respectively connecting the negative electrode leads 240 of the plurality of battery cells 200 and the charge/discharge portion 131. The cell activating portion 130 may be coupled to the cell fixing portion 120 so as not to interfere with the rotation of the cell fixing portion 120.

For example, the charge/discharge portion 131 may be fixed on the uppermost support plate 126a. In another example, as illustrated in FIG. 8, the charge/discharge portion 131 may be fixed below the lowermost support plate 126d. In addition, at least a portion of each of the plurality of positive electrode connectors 132 and the plurality of negative electrode connectors 133 may be fixed to at least one support plate among the plurality of support plates 126, e.g., to the lowermost support plate 126d.

The rotating shaft 141 of the cell rotating portion may be fixed to one of the plurality of support plates 126. For example, if the charge/discharge portion 131 is disposed below the lowermost support plate 126d, the rotating shaft 141 may be disposed on the uppermost support plate 126a. In another example, as illustrated in FIG. 8, the rotating shaft 141 may be disposed between two support plates, e.g., between support plates 126b and 126c. The rotating shaft 141 may be parallel to the height direction (H direction in FIG. 4) of the battery cells 200, and may be positioned correspondingly between two adjacent battery cells 200 along the horizontal direction.

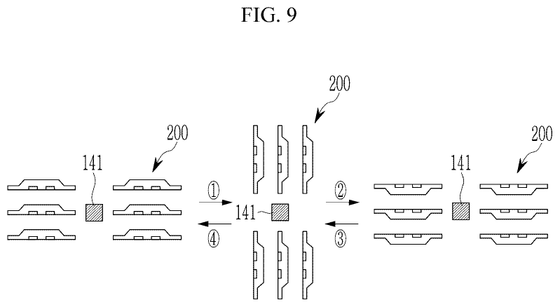

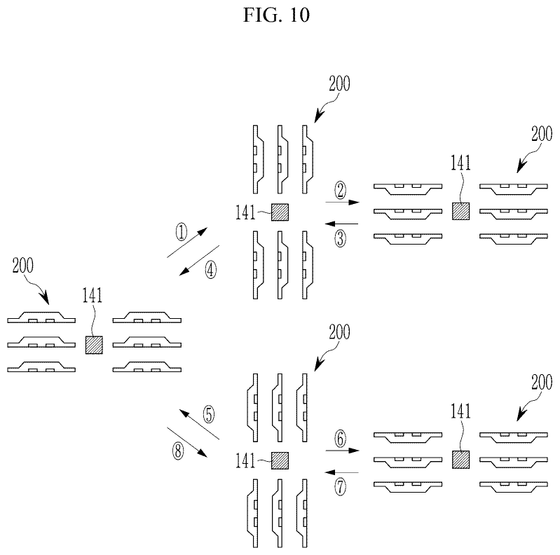

FIG. 9 and FIG. 10 illustrate schematic views of a rotation process of a plurality of battery cells using the rotating charge/discharge device 100A illustrated in FIG. 8.

For example, referring to FIG. 8 and FIG. 9, the cell activating portion 130 repeatedly performs charging, aging, and discharging of the plurality of battery cells 200, and during this process, the cell rotating portion rotates the cell fixing portion 120 so that the plurality of battery cells 200 simultaneously rotate. During the activating process of the battery cells 200, the cell rotating portion may repeat an operation of rotating the plurality of battery cells 200 by 180° in the first direction and then rotating the plurality of battery cells 200 by 180° in the second direction. In FIG. 8, an example in which the first direction is clockwise is shown.

In another example, referring to FIG. 8 and FIG. 10, the cell rotating portion may perform the rotating operation in the second direction and the rotating operation in the first direction after the rotating operation in the first direction and the rotating operation in the second direction. In this case, the electrolyte solution alternately flows between the left and right portions of the battery cell 200 during the rotation of the battery cell 200, so that the electrolyte solution may be more uniformly impregnated into the entire electrode assembly. In FIG. 10, an example in which the first direction is clockwise is shown.

The plurality of battery cells 200 are repeatedly turned upside down during the activating process, so that the electrolyte solution may be uniformly impregnated throughout the electrode assembly without pooling in a specific area of the electrode assembly. The rotating charge/discharge device 100A of the present embodiment may simultaneously activate the plurality of battery cells 200 and rotate the plurality of battery cells 200, thereby increasing the efficiency of the activating process.

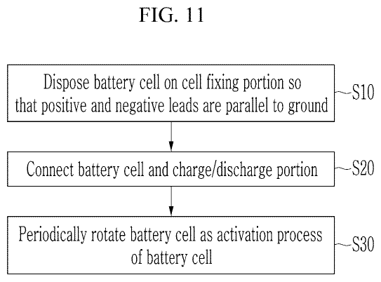

FIG. 11 illustrates a flowchart of a method of activating a secondary battery according to a third embodiment.

Referring to FIG. 11, the method of activating the secondary battery may include a battery cell disposing operation (S10) of disposing the battery cell on the cell fixing portion so that a thickness direction of the battery cell coincides with the direction of gravity, a battery cell connecting operation (S20) of electrically connect the battery cell to the charge/discharge portion, and a rotating activating operation (S30) of repeatedly charging, aging, and discharging the battery cells, and at the same time, rotating the cell fixing portion and the battery cell by the rotation of the rotating shaft. In this case, the rotating shaft is disposed parallel to the height direction of the battery cell (i.e., perpendicularly to the gravity direction).

Referring to FIG. 1 and FIG. 8, in the battery cell disposing operation (S10), the battery cell 200 is disposed and fixed to the cell fixing portion 120 so that the thickness direction (T direction in FIG. 4) thereof coincides with the direction of gravity and the height direction (H direction in FIG. 4) thereof is parallel to the ground. In FIG. 8, the plurality of battery cells 200 may form a plurality of layers and a plurality of columns to be disposed on the cell fixing portion 120.

In the battery cell connecting operation (S20), the positive electrode connector 132 is connected to the positive electrode lead 230 to electrically connect the charge/discharge portion 131 and the positive electrode lead 230, and the negative electrode connector 133 is connected to the negative electrode lead 240 to electrically connect the charge/discharge portion 131 and the negative electrode lead 240. In FIG. 8, the cell activating portion 130 may be provided with a plurality of positive electrode connectors 132 and a plurality of negative electrode connectors 133 to electrically connect the charge/discharge portion 131 and the plurality of battery cells 200. The cell activating portion 130 may be fixed to the cell fixing portion 120 to rotate together with the plurality of battery cells 200.

In the rotating activating operation (S30), the charge/discharge portion 131 may repeatedly perform a process of turning the power source on to charge the battery cells 200, turning the power source off for a certain period of time to age the battery cells 200, and turning the load on to discharge the battery cell 200. The aging is an operation of maintaining a constant temperature and humidity for sufficient impregnation of the electrolyte solution, and both the power source and the load are turned off.

Referring to FIG. 6 and FIG. 9, in the rotating activating operation (S30), a process in which the rotating shaft 141 is rotated 180° in the first direction by the rotating driver 142 to invert the upper and lower portions of the battery cell 200 and is rotated 180° in the second direction by the rotating driver 142 to again invert the upper and lower portions of the battery cell 200, is repeated. The cell rotating portion 140 may have a certain stop period between the rotating operation period in the first direction and the rotating operation period in the second direction.

Since the battery cell 200 is periodically flipped upside down during the activating process, the electrolyte solution may be uniformly impregnated throughout the electrode assembly. In addition, the positive electrode lead 230 and the negative electrode lead 240 are disposed parallel to the ground, and the rotating shaft 141 is disposed parallel to the positive electrode lead 230 and the negative electrode lead 240, so that the flow distance of the electrolyte solution within the battery cell 200 may be shortened. The shortening of the flow distance of the electrolyte solution facilitates the flow of the electrolyte solution and enables uniform impregnation.

Referring to FIG. 7 and FIG. 10, the cell rotating portion 140 may perform the rotating operation in the second direction and the rotating operation in the first direction after the rotating operation in the first direction and the rotating operation in the second direction. In this case, during the rotation of the battery cell 200, the electrolyte solution alternately flows between the left and right portions of the battery cell 200, so that the entire electrode assembly may be very uniformly impregnated with the electrolyte. Even in this case, the cell rotating portion 140 may have a certain stop period between the rotating operation period in the first direction and the rotating operation period in the second direction. The uniform impregnation of the electrolyte solution leads to improved output performance of the battery cell 200 and increased capacity of the battery cell 200.

By way of summation and review, the electrode assembly requires sufficient impregnation with an electrolyte solution. The electrolyte solution connects an electrode and pores of a separator to form an electrolyte solution channel, and the electrolyte solution channel requires stabilization to prevent the electrolyte solution from leaking from the electrode assembly. However, during the activation process, the electrolyte solution may be collected in the lower portion of the electrode assembly due to gravity, which inhibits uniform impregnation, thereby leading to a decrease in the output characteristics and capacity of the battery cell.

In contrast, the present disclosure provides a rotating charge/discharge device and a method of activating a secondary battery using the same that may improve output characteristics of the battery cell and increase capacity thereof by uniformly impregnating an entire electrode assembly with an electrolyte solution during an activation process of the secondary battery. That is, according to embodiments, the rotating charge/discharge device may be arranged and rotated in such a way that an electrolyte solution may be uniformly impregnated in an entire electrode assembly during a process of activating a battery cell. As a result, the output performance of the battery cell may be improved and the capacity of the battery cell may be increased.

The methods, processes, and/or operations described herein (e.g., periodic rotation of the cell rotating portion 140 and operation of the charge/discharge portion 131) may be performed by code or instructions to be executed by a computer, processor, controller, or other signal processing device. The computer, processor, controller, or other signal processing device may be those described herein or one in addition to the elements described herein. The algorithms, code or instructions for implementing the operations of the method embodiments herein may transform the computer, processor, controller, or other signal processing device into a special-purpose processor for performing the methods herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, or controller which is to execute the code or instructions for performing the method embodiments described herein.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A rotating charge/discharge device, comprising:
a cell fixing portion configured to fix at least one battery cell, a major surface of the cell fixing portion being perpendicular to a gravity direction;
a cell activating portion that includes a charge/discharge portion, a positive electrode connector connecting a positive electrode lead of the at least one battery cell and the charge/discharge portion, and a negative electrode connector connecting a negative electrode lead of the at least one battery cell and the charge/discharge portion, the cell activating portion being configured to charge and discharge the at least one battery cell; and
a cell rotating portion that includes a rotating shaft coupled to the cell fixing portion and a rotating driver rotating the rotating shaft, the rotating shaft extending in parallel to the major surface of the cell fixing portion, and the rotating driver being configured to periodically rotate the rotating shaft with the cell fixing portion during an activating process of the at last one battery cell.

2. The rotating charge/discharge device of claim 1, wherein the charge/discharge portion includes a power source and a load, the charge/discharge portion being configured to charge the at least one battery cell via the power source and to discharge the at least one battery cell via the load.

3. The rotating charge/discharge device of claim 1, wherein each of the positive electrode connector and the negative electrode connector is a connecting line, the connecting line having a length that allows free movement if the cell fixing portion rotates.

4. The rotating charge/discharge device of claim 1, wherein:
the rotating shaft extends in parallel to a height direction of the at least one battery cell,
the rotating driver is coupled to a first end of the rotating shaft, and
a second end of the rotating shaft is supported by a bearing.

5. The rotating charge/discharge device of claim 1, wherein the cell fixing portion includes a lower plate configured to support the at least one battery cell, an upper plate in parallel to the lower plate and covering the lower plate, and a fastening portion coupling the upper plate and the lower plate and configured to adjust pressure between the upper plate and the lower plate.

6. The rotating charge/discharge device of claim 5, wherein the rotating shaft is fixed to one of the upper plate and the lower plate, the rotating shaft overlapping a central axis of the cell fixing portion.

7. The rotating charge/discharge device of claim 1, wherein the cell fixing portion includes a plurality of stacked support plates and a fastening portion coupling the plurality of stacked support plates to each other, the plurality of stacked support plates being configured to support a plurality of battery cells in a plurality of layers and a plurality of columns between the plurality of support plates.

8. The rotating charge/discharge device of claim 7, wherein:
a plurality of the positive and negative electrode connectors connect the plurality of battery cells and the charge/discharge portion, and
the plurality of positive and negative electrode connectors and the charge/discharge portion are fixed to one of the plurality of support plates.

9. The rotating charge/discharge device of claim 7, wherein the rotating shaft is fixed to at least one of the plurality of support plates, the rotating shaft extending in parallel to a height direction of the plurality of battery cells between two adjacent columns of the plurality of columns.

10. A method of activating a secondary battery, the method comprising:
disposing and fixing at least one battery cell onto a cell fixing portion so that a thickness direction of the at least one battery cell coincides with a gravity direction, the cell fixing portion including a rotating shaft in parallel to a height direction of the at least one battery cell;
electrically connecting the at least one battery cell to a charge/discharge portion; and
activating the at least one battery cell by repeatedly performing charging, aging, and discharging by an operation of the charge/discharge portion, and at the same time, rotating the cell fixing portion and the at least one battery cell by rotation of the rotating shaft.

11. The method of activating the secondary battery of claim 10, wherein:
disposing and fixing the at least one battery cell includes disposing and fixing a plurality of battery cells in a plurality of layers and a plurality of columns in the cell fixing portion, and
the rotating shaft is disposed correspondingly between two adjacent columns among the plurality of columns.

12. The method of activating the secondary battery of claim 11, wherein:
electrically connecting the at least one battery cell to the charge/discharge portion includes electrically connecting the charge/discharge portion to each of the plurality of battery cells by a plurality of positive electrode connectors and a plurality of negative electrode connectors, and
each of the charge/discharge portion, the plurality of positive electrode connectors, and the plurality of negative electrode connectors is fixed to the cell fixing portion, and rotates together with the cell fixing portion during rotation of the rotating shaft.

13. The method of activating the secondary battery of claim 10, wherein activating the at least one battery cell includes repeatedly rotating the rotating shaft in a first direction by 180° to invert upper and lower portions of the at least one battery cell and rotating the rotating shaft in a second direction by 180° to invert the upper and lower portions of the at least one battery cell back.

14. The method of activating the secondary battery of claim 13, wherein activating the at least one battery cell includes rotating the rotating shaft repeatedly by 180° in the first direction, by 180° in the second direction, by 180° in the second direction, and by 180° in the first direction, in the stated order.

15. The method of activating the secondary battery of claim 13, wherein activating the at least one battery cell includes stopping the rotating shaft for a rotating stop period between rotations in the first direction and the second direction.
